(19) United States
(12) Patent Application Publication
(10) Pub. No.: US 2009/0259772 A1
(43) Pub. Date: Oct. 15, 2009

(54) APPARATUS FOR A USER REMOVABLE MEMORY OR A DEVICE FOR COMMUNICATION WITH A USER REMOVABLE MEMORY, AND ASSOCIATED METHODS

(75) Inventors: Jarmo Tapio Ketko, Tampere (FI); Jussi Veikko Tapio Takaneva, Tampere (FI); Aarno Juhani Jussila, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/101,587

(22) Filed: Apr. 11, 2008

(51) Int. Cl. G06F 13/00; G06F 12/00

(52) U.S. Cl. 710/13; 711/115; 711/E12.008

(57) ABSTRACT

There is provided an apparatus for a user removable memory or a device for communication with a user removable memory, the apparatus comprising interface circuitry configured to provide for power transmission signalling between a user removable memory and a device for communication with the user removable memory, the interface circuitry comprising at least one reactive coupling element to provide for the power transmission signalling, via reactive coupling.

### TECHNICAL FIELD

The present invention relates to the field of user removable memory, associated apparatus (including associated readers for user removable memory) and methods.

Certain embodiments of the invention relate to user removable memory for portable electronic devices and the like. In particular, so-called hand-portable electronic devices that may be hand-held in use (although they may be placed in a cradle in use). Such hand-portable electronic devices include so-called Personal Digital Assistants (PDAs).

Such portable electronic devices may provide one or more audio/text/video communication functions (e.g. telecommunication, videocommunication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

Certain embodiments related also relate to such devices per se (or reader modules of such devices), and/or other devices/modules of such other devices, used to read the content of associated user removable memory.

### BACKGROUND

Memory cards, such as flash memory cards, smartcards, and the like, have been proven a good memory solution for many different applications. This is due in part to their size, capaciousness, speed, and resistance to kinetic shock.

The proliferation of such cards is attributed, in part, to these characteristics. Such memory cards (and their associated readers) are being provided with the intention that the cards should be portable between different apparatus (i.e. easily removable and interchangeable). For example, removable flash memory cards for mobile phones/digital cameras, portable chip cards for credit cards (so-called IC credit/chip and pin cards), etc.

For data to be communicated between card and reader (e.g. between a memory of the card and a memory of a device), the continuity of the connection path must be maintained. Erosion/ablation of contacts, deformation of chip/contacts due to contact spring forces, contact spring malfunction, electrostatic discharge (e.g. when handling cards), and an increase in corrosion/electromagnetic interference due to the removal of galvanic surfaces, all reduce (sometimes significantly) the ability of such cards/readers to communicate with one another, sometimes during high speed data transfer.

The listing or discussion of a prior-published document or any background in this specification should not necessarily be taken as an acknowledgement that the document or background is part of the state of the art or is common general knowledge.

### SUMMARY

In a first aspect, there is provided an apparatus for a user removable memory or a device for communication with a user removable memory, the apparatus comprising interface circuitry configured to provide for power transmission signalling between a user removable memory and a device for communication with the user removable memory, the interface circuitry comprising at least one reactive coupling element to provide for the power transmission signalling, via reactive coupling.

The interface circuitry may be additionally configured to provide for data communication signalling via the at least one reactive coupling element.

The interface circuitry may be configured to provide for power transmission signalling of the user removable memory via inductive coupling. The interface circuitry may be configured to provide for power transmission signalling including inductive powering of the user removable memory via the inductive coupling.

The interface circuitry may be configured to provide for data communication signalling via a capacitive reactive coupling element, and power transmission signalling via an inductive reactive coupling element.

The apparatus may be configured to provide for selective power/data signalling based on a predetermined criterion. The predetermined criterion may be the particular frequency of the signalling. The predetermined criterion may be the data rate of the signalling.

The apparatus maybe configured to provide for power transmission signalling via one particular reactive element (such as an inductive reactive element), and data communication signalling via a further reactive coupling element (such as a capacitive coupling element). Alternatively/additionally the apparatus may be configured to provide for power transmission signalling and data communication signalling via the same reactive element. The apparatus may be configured to provide for simultaneous power transmission signalling and data communication signalling via the same reactive element.

The apparatus may be configured such that respective reactive coupling elements are configured to communicate over the range of millimetres, such as 10 mm, 5 mm, 3 mm, 2 mm, 1 mm, 0.5 mm 0.25 mm, or any distance therebetween.

The, some, or each, reactive coupling element may be associated with at least one concentrator, to provide for reactive coupling (e.g. improved reactive coupling, when compared to an apparatus with no concentrator).

The apparatus may be comprised with an apparatus for communication with the user removable memory (e.g. a card reader/writer). The apparatus may be comprised with a user removable memory.

The concentrator may be one of a dielectric (e.g. a dielectric layer), and/or a flux concentrator (e.g. such as a ferrite, etc.).

The, some, or each, concentrator may comprise a dielectric layer to provide for capacitive reactive coupling and/or a flux concentrator to provide for inductive reactive coupling. The concentrator may be provided on the reactive coupling element, such as affixed on.

The apparatus may be configured to use a dielectric layer provided by a spacing, such as a capacitive gap (e.g. air gap), which may be defined between a capacitive reactive coupling element and a complementary capacitive reactive coupling element when the user removable memory and the apparatus for communication are positioned for signalling.

The apparatus may comprise the concentrator. The concentrator may be provided by the interface circuitry (such as a casing or a portion thereof). The concentrator may be embedded (such as fully/partially embedded) in a portion of the apparatus comprising the interface circuitry.

The reactive coupling element may be located proximal to the exterior of the apparatus, such as at a surface region so as to be exposed, or embedded (e.g. fully embedded), or the like.

The apparatus may be additionally configured for mating coupling. The apparatus may be additionally configured for galvanic mating coupling. The apparatus may comprise a mating coupling element, to provide for mating coupling with a complementary mating coupling element in another apparatus. The mating coupling element may be one of a connection element, and a complementary protruding element. The protruding element may be configured so as to provide mechanical connection (e.g. holding against) with the connection element, when apparatuses are in use. The protruding element may comprise a deformable resilient portion, such as spring, or the like.

The apparatus may be configured to provide for selective use of mating (e.g. galvanic) and reactive coupling. The apparatus may be configured to provide for selective use based on a predetermined criterion. The predetermined criterion may be the particular required speed of signalling (e.g. data rate). The predetermined criterion may be the particular frequency of signalling (e.g. the minimum/maximum frequency of a signal in which there is provided communication signalling).

The predetermined criterion may be the requirement for signalling of one of: differential signalling; single ended transmission; and power transmission. The interface circuitry may be configured to provide for use of mating (e.g. galvanic) coupling for power supply to the user removable memory, and to provide for capacitive coupling for data communication.

The apparatus may be configured to provide for conditioning of a signal for power/data signalling. The apparatus may be configured to provide for a particular minimum frequency of a signal for data communication signalling, such as by altering the signal.

According to a second aspect of the present invention there is provided an apparatus according to any features of the first aspect, in which the apparatus is one of: a user removable memory; a module for a user removable memory; a device for communication with a user removable memory; a module for a device for communication with a user removable memory; an adapter, or module for an adapter, configured for attachment to a user removable memory/device for communication with a user removable memory.

The user removable memory (or module for the user removable memory) may be one of: a subscriber identity module; a smart card; an integrated circuit card (such as an internally housed integrated circuit card); a flash memory card; and a credit card.

The device for communication with a user removable memory (or module for a device for communication with a user removable memory) may additionally comprise circuitry, such as processing and memory circuitry, for communicating to/from a further apparatus.

The device for communication with a user removable memory (or module for a device for communication with a user removable memory) may be provided with: a portable electronic communications device (e.g. a mobile telephone, GPS device, etc.); multimedia player; gaming device; camera (e.g. digital camera); automated teller machine; point of sale apparatus, etc.

The adapter (or module for an adapter) may comprise mating connection circuitry to provide for mating connection to mating interface circuitry of the user removable memory or device. The adaptor may comprise at least one reactive coupling element for signalling with a respective device for signalling with the user removable memory or user removable memory. The adapter may be configured to adapt the signalling from/to the user removable memory or respective device, via the at least one reactive coupling element.

According to a third aspect there is provided a computer program, the computer program comprising computer code to control operation of an apparatus for a user removable memory or a device for communication with a user removable memory, the apparatus comprising interface circuitry configured to provide for power signalling between a user removable memory and an apparatus for communication with the user removable memory, the interface circuitry comprising at least one reactive coupling element to provide for the power transmission signalling, via reactive coupling, the computer code configured to control power transmission signalling via the reactive coupling.

The interface circuitry may be additionally configured to provide for data communication signalling, and the computer code may be configured to control power/data signalling using at least one reactive coupling element, according to a predetermined criterion.

The predetermined criterion may be the particular required speed of communication signalling (e.g. data rate). The predetermined criterion may be the particular frequency of communication signalling (e.g. the minimum/maximum frequency in a signal provided for communication signalling).

According to a fourth aspect there is provided means for reading/writing data to a user removable means for memory, the means for reading/writing data comprising means for interfacing configured to provide for power transmission signalling between the user removable means for memory and a means reading/writing data to/from the user removable means for memory, the means for interfacing comprising at least one means for reactive coupling to provide for the power transmission signalling, via reactive coupling.

According to a fifth aspect there is provided a method of providing power transmission signalling between an apparatus for a user removable memory and a device for communication with the user removable memory, the method comprising providing power transmission signalling via reactive coupling.

The method may further comprise providing data communication signalling between an apparatus for a user removable memory and a device for communication with the user removable memory. The method may further comprise providing data communication signalling via reactive coupling.

The present invention includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1 shows an embodiment of interface circuitries;

FIG. 2 shows a plan view of interface circuitries comprising a number of mating elements;

FIG. 3 shows an embodiment of interface circuitries comprising reactive coupling elements;

FIG. 4 shows a plan view of interface circuitries comprising a number of reactive coupling elements;

FIG. 5 shows interface circuitries comprising reactive coupling elements and concentrators;

FIG. 6 shows interface circuitries in which reactive coupling elements are at least partially embedded;

FIG. 7 shows interface circuitries comprising reactive coupling elements and mating coupling elements;

FIG. 8 shows an embodiment of interface circuitry configured for signal conditioning/element selection;

FIG. 9 shows an embodiment of interface circuitry as an adapter; and

FIG. 10 shows flow charts of providing for communication signalling of a user removable memory using interface circuitry and reactive coupling.

### DESCRIPTION OF SPECIFIC EMBODIMENTS

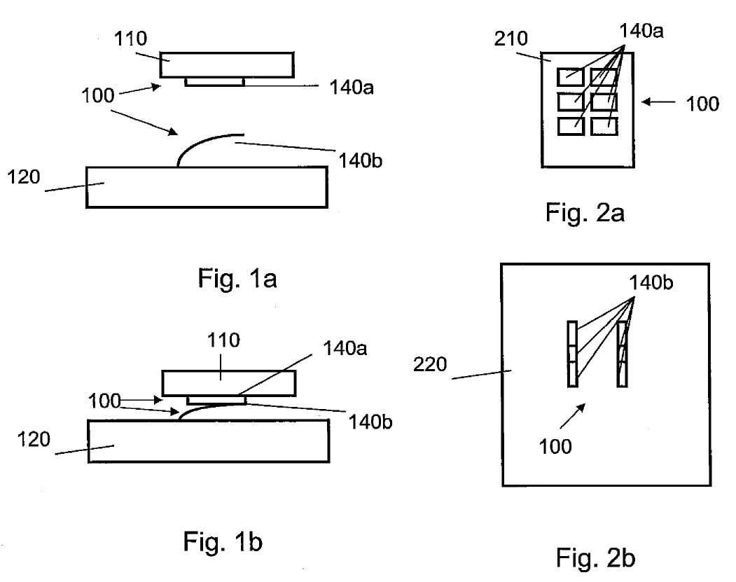

FIG. 1a shows a side view of an embodiment of interface circuitry 100, configured to provide for signalling, for background understanding. In this embodiment, there is provided a user removable memory 110, which in the present embodiment is provided by a flash memory card, or the like, and a device 120 for communication with the user removable memory 110, which in the present embodiment is provided by a reader for the user removable memory. It will readily be appreciated that such a reader may also be able to write data to the user removable memory.

Both the memory 110 and the reader 120 comprise interface circuitries 100, which are configured, using mating coupling elements 140a, 140b, to provide for signalling between the memory 110 and the reader 120. The mating coupling element 140a of the memory 110 is provided by a connection element 140a. The mating coupling element 140b of reader 120 is provided by a protruding element 140b, which in the present embodiment is provided by a deformable (resilient) protruding element 140b. Although not shown here for clarity reasons, each mating coupling element 140a, 140b is in communication with further respective circuitry of the memory 110/reader 120, as will be readily understood by the skilled reader. In this embodiment, each mating coupling element 140a, 140b is provided by galvanic mating coupling elements.

FIG. 1b shows a side view of interface circuitries 100 in use. Here, the memory 110 and the reader 120 are brought into proximity with one another, so as to provide for a mating coupling between the interface circuitries 100. In this embodiment, the protruding element 140b is elastically deformed against the connection element 140a. In this configuration there is provided electrical continuity between the mating coupling elements 140a, 140b. There is therefore provided electrical continuity between the further circuitries of the memory 110/reader 120. It will readily be appreciated that as the protruding element 140b has been deformed (in this configuration) it is forced against the connection element 140a (when in use), so as to provide for maintained continuity.

In this embodiment, data communication signalling and power transmission signalling may be communicated between the interface circuitries, and therefore between the further circuitries of the memory 110 and reader 120.

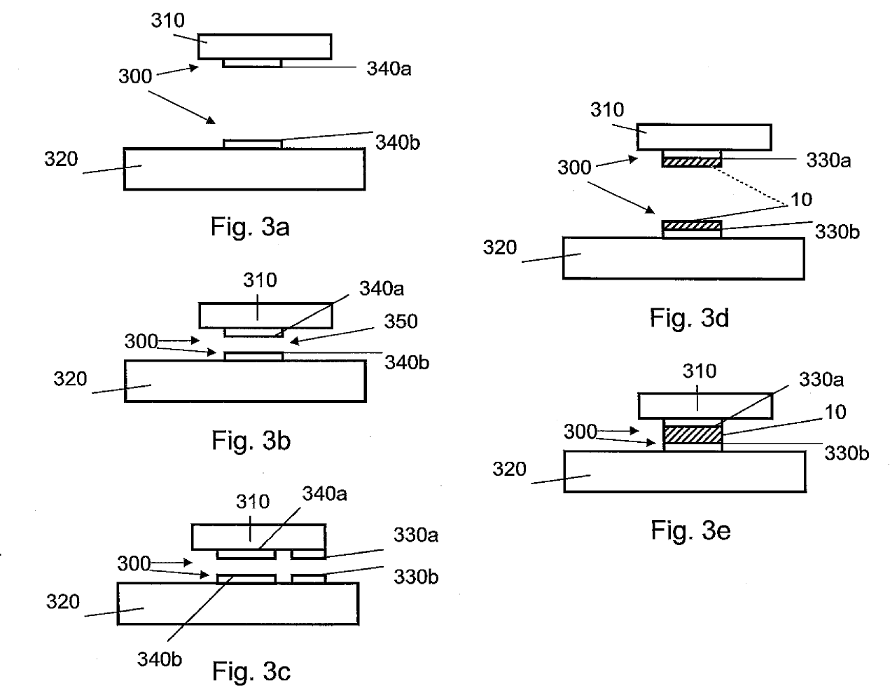

FIGS. 2a and 2b show a plan view of a memory 210 and a reader 220 respectively, in which the respective interface circuitries 100 comprise a plurality of mating coupling elements 140a, 140b. It will be readily appreciated that when the interface circuitries 100 are coupled, that signalling may be provided between the memory 210 and the reader 220. The signalling may comprise any one of: differential signalling (e.g. using two pairs of mating coupling elements), single ended signalling, power signalling (including providing a ground, or relative ground), etc., or a combination thereof.

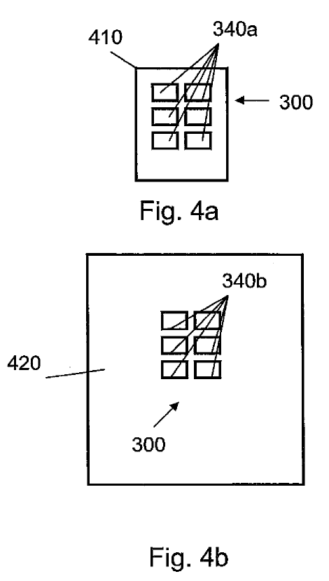

FIG. 3a shows an embodiment of interface circuitry 300, configured to provide for data communication signalling and power transmission signalling. In this embodiment, there is provided a user removable memory 310, which in the present embodiment is provided by a flash memory card, or the like, and a device 320 for communication with the user removable memory 310, which in the present embodiment is a removable memory reader.

Both the memory 310 and the reader 320 comprise interface circuitries 300, which are configured, using (complementary) reactive coupling elements 340a, 340b, to provide for signalling between the memory 310 and the reader 320. In the present embodiment, each reactive coupling element 340a, 340b is provided by a capacitor element, such as an electrode pad (e.g. copper, aluminium (aluminum), etc.), so as to provide for capacitive coupling. In the present embodiment, each capacitive coupling element 340a, 340b is provided as an electrode pad on a surface region of the memory 310 and reader 320 respectively. In this embodiment, each capacitive coupling element 340a, 340b is configured to be in communication with further circuitry of the memory 310 and reader 320 respectively, as will be readily appreciated.

FIG. 3b shows a side view of interface circuitries 300 in use. Here, the memory 310 and the reader 320 are brought into proximity with one another, so as to provide for a capacitive coupling between the capacitive coupling elements 340a, 340b of the interface circuitries 300. In this embodiment, the capacitive coupling elements 340a, 340b are brought together in such a manner that there is provided a gap 350 (e.g. a capacitive gap) between the two capacitive coupling elements 340a, 340b (i.e. they are not mechanically touching). In this embodiment, the gap 350 is provided by an air gap. In alternative embodiments, this need not be the case, and the gap 350 may be provided (or a least partially provided) by an alternative gas, and/or a dielectric (such as a dielectric layer), as will be described.

In this embodiment, data communication signalling (having at least an oscillatory component) may be communicated between the interface circuitries 300 by using the capacitive coupling elements 340a, 340b and the gap 350. In such an arrangement, data communication signalling may be provided between further circuitries of the memory 310 and reader 320.

The capacitive coupling elements 340a, 340b are additionally be configured for power transmission signalling (e.g. inductive powering) of the interface circuitries 300. In such arrangements, the interface circuitries 300 may be configured to provide for a capacitive configuration (e.g. a pseudo capacitor plate (e.g. flat plate) configuration) during data communication signalling, and configured to provided for an inductive configuration (e.g. a pseudo inductor (e.g. coil)) during inductive coupling. In some embodiments, the interface circuitry 300 may be provided with at least one particular coupling element configured to provide for data communication signalling, and at least one particular coupling element configured to provide for power (e.g. inductive) transmission signalling. A skilled reader would readily be able to implement such arrangements.

Power transmission signalling provides power between (e.g. one or more of to and/or from) the user removable memory/device for communication with the user removable memory to allow for reading/writing of data to/from the memory.

In further embodiments still, and as shown in FIG. 3c, the interface circuitry 300 may be provided with further reactive coupling elements 330a, 330b, which here are shown in addition to capacitive coupling elements 340a, 340b. Here, the reactive coupling element 330a of the interface circuitry 300 of the memory 310 is configured to receive signalling (e.g. data communication/power transmission signalling) from the reactive coupling element 330b of the interface circuitry 300 of the reader 320.

Each reactive coupling element 330a, 330b is provided by an inductor configuration (e.g. an inductive coil, or the like). In other words, the further reactive coupling elements 330a, 330b are provided by inductive coupling elements 330a, 330b (compared to being provided by capacitive coupling elements 340a, 340b). The inductive coupling element 330b of the interface circuitry 300 of reader 320 is configured to use an oscillatory signal (e.g. by using an oscillator, such as an oscillator configured to provide a frequency at around the resonant frequency of the inductive coupling elements 330a, 330b). The inductive coupling element 330a of the interface circuitry 300 of memory 310 is configured to use (i.e. receive) an oscillatory signal (e.g. by induction), to provide for powering of the memory 310. When using dc logic (e.g. CMOS, TTL) one of: the inductive coupling element 330a; interface circuitry 300; memory 310 is configured to rectify the power transmission signalling received from the inductive coupling element 330b of the reader 320. In some embodiments, the inductive coupling elements 330a, 330b are further configured to provide for data communication signalling. In alternative embodiments, the inductive coupling elements 330a, 330b may be configured additionally/alternatively for data communication (in a similar manner to the capacitive coupling elements 340a, 340b).

In some embodiments one or both of the inductive coupling elements 330a, 330b may further be provided with a concentrator, such as a flux concentrator (e.g. iron flux concentrator), or the like. A concentrator of such a configuration is provided to reduce inductive flux leakage during communication. FIG. 3d shows the interface circuitries 300 comprising inductive reactive coupling elements 330a, 330b. FIG. 3e shows each interface circuitry 300 comprising a concentrator 10, configured to provide for improved flux linkage between respective inductive coupling elements 330a, 330b when in use, compared to the flux linkage when no concentrator 10 is provided.

In the embodiment of FIGS. 3c, 3d, and 3e, the interface circuitries 300 are configured to provide for power transmission signalling between the respective interfaces 300 using the inductive reactive coupling elements 330a, 330b. In addition, the interface circuitries are configured to provide for data communication signalling.

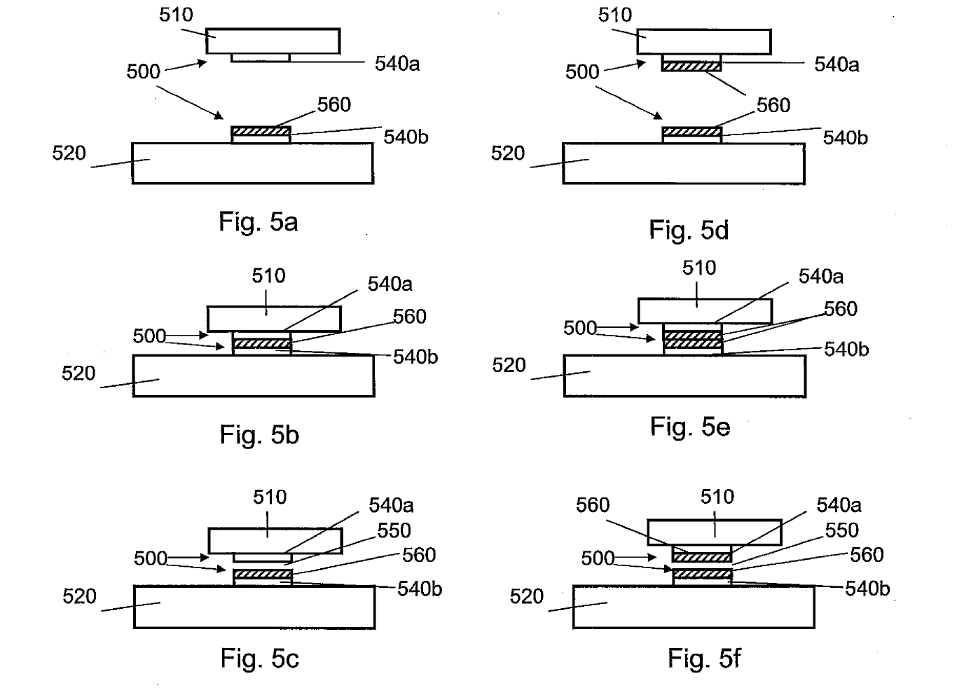

In other embodiments, the interface circuitries may be provided with any number of reactive coupling elements 340a, 340b, 330a, 330b, to provide for reactive coupling (e.g. FIG. 4). One, some, or all of the reactive coupling elements may be provided so as to provide for data/power signalling. In addition, one, some, or all of the reactive coupling elements may be provided with a concentrator. In arrangements in which there is provided capacitive coupling elements 340a, 340b, one, some or all of the capacitive coupling elements 340a, 340b, may be provided with concentrator(s), such as dielectric layers.

In some embodiments, in which there is provided both capacitive and inductive coupling elements, power and/or data signalling may be provided by respective of the same coupling element configurations. For example, inductive reactive coupling elements may be used to a modulated signal (e.g. frequency modulated) to communicate power and data to a further device/apparatus. Alternatively, a particular set of coupling elements may be provided for a particular signalling (e.g. capacitive solely for data, inductive solely for power).

FIG. 4 shows a plan view of a memory 410 and a reader 420 in which the interface circuitries 300 comprise a plurality of reactive coupling elements 340a, 340b. It will be readily appreciated that when the interface circuitries 300 are brought into proximity with each other, that signalling may be provided between the memory 410 and the reader 420. The communication signalling may comprise any one of: differential signalling, single ended signalling, power signalling (e.g. inductive powering), etc., or combination thereof.

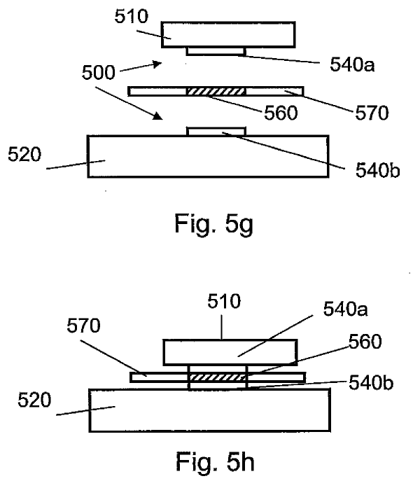

FIG. 5a shows a further embodiment, similar to FIG. 3a, in which there is provided interface circuitry 500, configured to provide for signalling (in a similar manner to that described above). In this embodiment, there is provided a user removable memory 510, which in the present embodiment is provided by a flash memory card, or the like, and a device 520 for communication with the user removable memory 510, which in the present embodiment is a reader for the user removable memory.

Both the memory 510 and the reader 520 comprise interface circuitries 500, which are configured, using (complementary) reactive coupling elements 540a, 540b, to provide for communication signalling between the memory 510 and the reader 520. In the present embodiment, each coupling element 540a, 540b is provided by a capacitive element, such as an electrode pad (e.g. copper, aluminium (aluminum), etc.). In the present embodiment, each capacitive coupling element 540a, 540b is provided as an electrode pad on a surface region of the memory 510 and reader 520 respectively. In this embodiment, each capacitive coupling element 540a, 540b is in communication with further circuitry of the memory 510 and reader 520 respectively.

Here, the capacitive coupling element 540b of the interface circuitry 500 of the reader 520 is further provided with a dielectric layer 560 as a concentrator. The dielectric layer 560 is configured to improve the capacitive coupling between capacitive coupling elements 540a, 540b, when in use. In the present embodiment, the dielectric layer 560 is provided on the capacitive coupling element 540b (e.g. attached to a surface thereof), such that, when in use, the dielectric layer is provided between the capacitive coupling layer 540a of the memory 510 and the capacitive coupling layer 540b of the reader 520. FIG. 5b shows a side view of this arrangement.

In use (as shown in FIG. 5b), the memory 510 and the reader 520 are brought into proximity with one another, so as to provide for a capacitive coupling between the capacitive coupling elements 540a, 540b of the interface circuitries 500. The capacitive coupling elements 540a, 540b are brought together in such a manner that the dielectric layer 560 is able to make contact (e.g. touching contact) with the capacitive coupling element 540a of memory 510.

In this embodiment, power/data signalling (having at least an oscillatory component) may be communicated between the interface circuitries 500 by using the capacitive coupling elements 540b, 540b and the dielectric layer 560. In such an arrangement signalling may be provided between further circuitries of the memory 510 and reader 520.

It will readily be appreciated that in some embodiments, the interface circuitries 500 may be configured such that, when in use, the dielectric layer is provided between the capacitive coupling layer 540a of the memory 510 and the capacitive coupling layer 540b of the reader 520 in addition to an capacitive gap 550 (e.g. an air gap). FIG. 5c shows a side view of this arrangement. Additionally, while in this embodiment the dielectric layer 560 is provided with the interface circuitry 500 of the reader 520, in alternative embodiments this need not be the case, and the dielectric layer 560 may be provided with the memory 510. Additionally, both the interfaces circuitries 500 may be provided with a dielectric layer 560 as shown in FIGS. 5d, 5e, and 5f. The skilled reader will readily appreciate that in further embodiments still, the dielectric layer may be provided by a separate intermediate layer 570, configured in use to be positioned (e.g. by a user) between the interface circuitries 500, as shown in FIGS. 5g and 5h. It will readily be appreciated that the dielectric layer 560 may extend across an entire surface region of a capacitive coupling element 540a, 540b (or a portion thereof), or may extend for more than the surface region. A skilled reader would readily be able to implement the various embodiments accordingly.

Similarly, a skilled reader will appreciate that while in the above embodiments, various configurations are described in relation reactive coupling elements 540a, 540b that are capacitive, in other embodiments, inductive coupling elements may be provided. In such arrangements, the concentrator provided as a dielectric layer 560 may be provided by a flux concentrator. Similarly in some arrangements, the interfaces may be provided by any number of reactive coupling elements 540a, 540b, which may be a combination of capacitive and inductive elements.

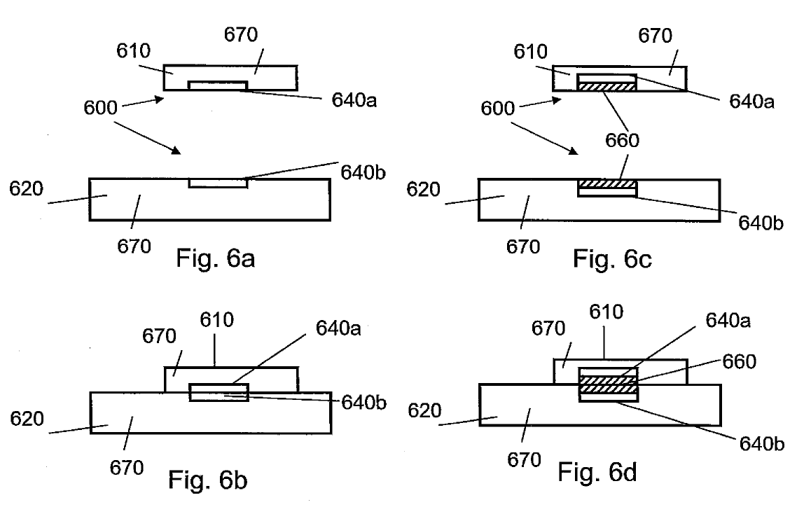

FIG. 6a shows a further embodiment, similar to FIG. 3a, in which there is provided interface circuitry 600, configured to provide for signalling (in a similar manner to that described above). In this embodiment, there is provided a user removable memory 610, which in the present embodiment is provided by a flash memory card, or the like, and an apparatus 620 for communication with the user removable memory 610, which in the present embodiment is a reader for a user removable memory.

Both the memory 610 and the reader 620 comprise interface circuitries 600, which are configured, using (complementary) reactive coupling elements 640a, 640b, to provide for communication signalling between the memory 610 and the reader 620, in a similar manner to that described previously. However, here each interface circuitry 600 is configured such that each reactive coupling element 640a, 640b is at least partially embedded in a portion of the memory 610 and reader 620 respectively (e.g. embedded in the respective casings). In this arrangement, each reactive coupling element 640a, 640b is fully embedded in a portion of memory 610/reader 620 (e.g. is not visible on, and is protected by, casing 670 of the reader 610/memory 620).

FIG. 6b shows this embodiment in use, wherein the memory 610 and the reader 620 are brought into proximity with one another so as to provide for a reactive coupling between the reactive coupling elements 640a, 640b of the interface circuitries 600. In this embodiment, the reader 620 and the memory are 610 are brought into contact with one another (i.e. touching contact). However, in other embodiments, this need not be the case, and, in use, there may be provided a gap between the interface circuitries 600, as will readily be appreciated.

FIGS. 6c and 6d show a further embodiment in which the casings 670 of the memory 610 and the reader 620 are provided with respective concentrators 660 (e.g. dielectric, flux concentrator). In this embodiment, each concentrator 660 forms a portion of the casings 670 in proximity to the respective reactive coupling elements 640a, 640b. Here, interface circuitries 600 are configured such that, when in use, concentrators 660 are configured to be positioned between the reactive coupling elements 640a, 640b. It will readily be appreciated that in some embodiments, only one concentrator 660 may be provide, which may be provided with the interface circuitry 600 of the memory 610, or the interface circuitry 600 of the reader 620. In use, the interface circuitries 600 are able to provide for communication signalling in a similar manner to that described above. Again, while in further embodiments still, each interface circuitry 600 may be configured to provide for a gap, such as a capacitive gap when using capacitive coupling elements.

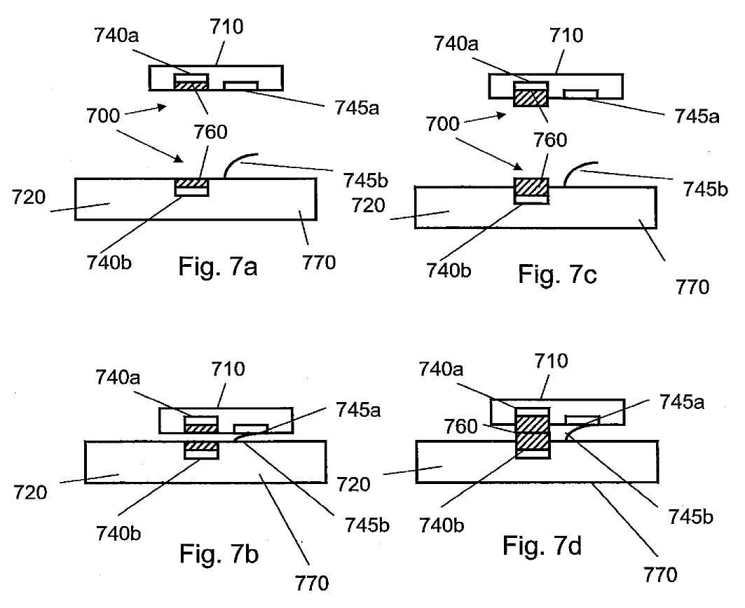

FIG. 7a shows a further embodiment of interface circuitries 700, configured to provide for signalling (in a similar manner to that described above). In this embodiment, there is provided a user removable memory 710, which in the present embodiment is provided by a flash memory card, or the like, and a device 720 for communication with the user removable memory 710, which in the present embodiment is a removable memory reader. In this exemplary embodiment, reactive coupling elements 740a, 740b (e.g. capacitive coupling elements, inductive coupling elements) are provided such that they are embedded in casing 770 of the respective interface circuitries 700. Additionally, each interface circuitry 700 is provided with a concentrator 760. In some embodiments there may be one, or no concentrator 760 provided, as will be appreciated.

Here, the interface circuitries 700 are configured using the (complementary) coupling elements 740a, 740b to provide for signalling between the memory 710 and the reader 720, in a similar manner to the described previously. However, here each interface circuitry 700 is additionally configured to provide for signalling using mating coupling elements 745a, 745b. In the present embodiment, the interface circuitry 700 of the memory 710 is provided with a connection element 745a, while the interface circuitry 700 of the reader 720 is provided with a protrusion element 745b (e.g. in a similar manner to that described in relation to FIGS. 1 and 2).

FIG. 7b shows this embodiment in use, wherein the memory 710 and the reader 720 are brought into proximity with one another, so as to provide for a reactive coupling between the reactive coupling elements 740a, 740b of the interface circuitries 700. In addition, mating coupling is provided as the mating coupling elements 745a, 745b are brought into touching contact.

FIGS. 7c and 7d show a further embodiment of the interface 700 in which respective concentrators 760 (e.g. dielectric layers for capacitive coupling elements, or flux concentrators for inductive coupling elements) are configured such that both the respective mating coupling elements 745a, 745b and the respective concentrators 760 are, in use, brought into touching contact with one another.

In these embodiments, signalling (having at least an oscillatory component) may be communicated between the interface circuitries 700 by using the reactive coupling elements 740a, 740b, and signalling (including having a DC bias) may be communicated between the interface circuitries 700 using the mating coupling elements 745a, 745b. In such arrangements signalling may be provided between further circuitries of the memory 710 and reader 720.

It will readily be appreciated that in this arrangement, when the interface circuitries 700 are configured for communication (e.g. positioned in proximity, and/or touching) such that power/data signalling may be provided between the memory 710 and the reader 720.

The signalling may comprise any one of: differential signalling (e.g. using two pairs of mating/reactive coupling elements), single ended signalling, power signalling (including providing a ground, or relative ground, inductive powering), etc., or a combination thereof.

In some embodiments, the interface circuitry (circuitries) 700 may be configured to select the coupling element 740a, 740b, 745a, 745b for providing a particular signalling. For example, in some arrangements, the interface circuitry 700 may be configured to select the reactive coupling elements 740a, 740b to provide for signalling (e.g. data) in excess of a particular frequency (e.g. high speed data transfers). In such an arrangement, the interface circuitry 700 may be configured to select the mating coupling elements 745a, 745b to provide for signalling (e.g. power) below a particular frequency (e.g. power communication signalling).

It will readily be appreciated that while only a single pair of reactive coupling elements 740a, 740b and a single pair of mating coupling elements are described 745a, 745b, in other embodiments, there may be provided any number of mating/reactive coupling elements. In addition, the reactive coupling elements 740a, 740b may be any of capacitive and inductive coupling elements, or combination thereof.

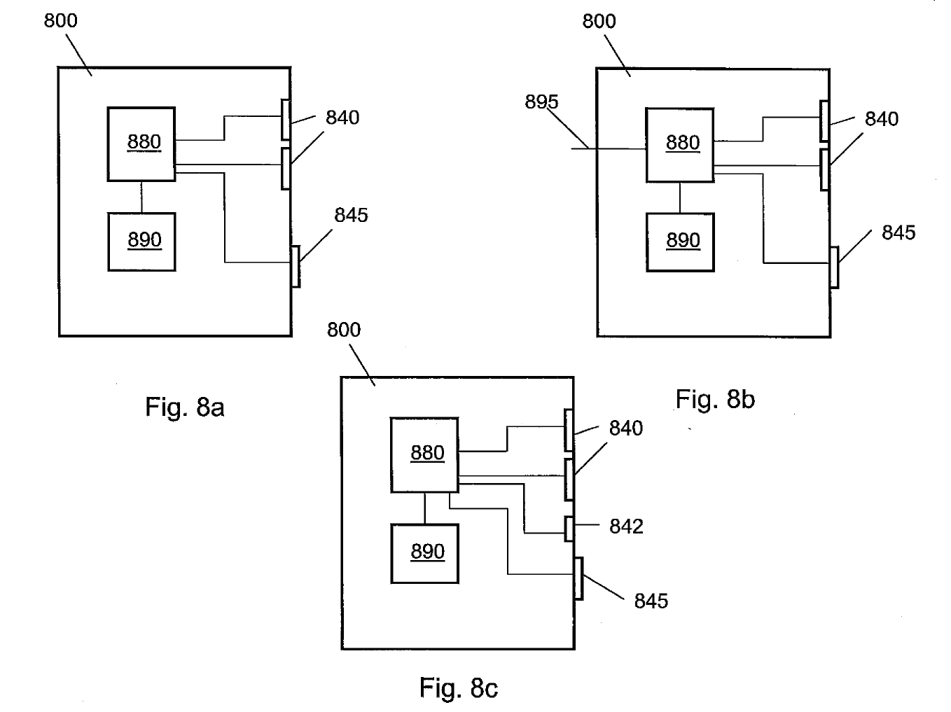

FIG. 8a shows an embodiment of an interface circuitry 800, (similar to an interface circuitry 300, 500, 600, 700 as described in the embodiments), in which in this exemplary embodiment there is provided two capacitive coupling elements 840 and a mating coupling element 845. Each of the coupling elements 840, 845 are configured to provide for signalling with complementary coupling elements 840, 845 of further interface circuitry 800.

The interface circuitry 800 further comprises a processor 880 and a memory 890, configured in a known manner. The processor 880 is in communication with the coupling elements 840, 845 and is configured to provide for signalling. In this arrangement, the processor 880 is configured to select the particular coupling element 840, 845, based upon the frequency of the signalling, and/or the capacitance of the capacitive coupling element (when in use) to provide for the said signalling. It will readily be appreciated that the processor 880 may be configured to provide particular signalling at, or above, a particular frequency, based upon the capacitive coupling.

FIG. 8b shows a further embodiment of the interface circuitry 800 in which the processor 880 is in communication with the coupling elements 840, 845 and is configured to provide for signalling. In this arrangement, the processor 880 is further configured to communicate with another apparatus (e.g. wired communication, wireless communication, etc.), via a connection path 895. Here, the interface circuitry 800, and in particular the processor 880 is configured to provide for signalling conditioning of data communication signals (e.g. a digital communication signal) to be communicated to/from the other apparatus using either of the capacitive coupling elements 840. In this embodiment, a data communication signal, being provided to the processor 880 for capacitive communication, is processed (if necessary) to ensure that the signal does not contain frequencies less than a predetermined frequency. Such an arrangement may use Manchester coding, 8b/10b coding, 50% duty clock cycle (such a coding providing for DC balancing), or the like.

In this embodiment, the highest allowable −3 dB frequency of a particular capacitive coupling element 840 is configured to be roughly half the lowest frequency content in the digital communicated signal. For example, if the −3 dB frequency was 200 kHz, then the lowest frequency that would be allowed to be transmitted would be 400 kHz. In other embodiments the highest allowable −3 dB frequency may be roughly two thirds (e.g. f_{-3db}=200 kHz, fₘᵢₙ=300 kHz); one third; one quarter; one fifth or the like, etc. In some embodiments the lowest frequency that would be allowed to be transmitted would be the same as the −3 dB frequency.

For example, when encoding using 8b/10b, the run-length is limited to five consecutive bits. That is that five consecutive bits of the data communication signal (e.g. digital signal), may, in some cases, be the same, thus providing for a lower apparent frequency that the frequency (i.e. data rate) of the data communication signal. Therefore, in the arrangement where there is provided (for example) a 2 Gb/s data communication signal, there can be frequencies as low as 200 MHz. When the interface circuitry 800 is configured as a 50Ω interface, the capacitance value of the capacitive coupling element 840, when in use, is might be in the region of 32 pF for such a signal. Such a capacitive value may be provided by a capacitive coupling element 840 of 1 mm² that, when in use, is separated from another respective capacitive coupling element 840 of 1 mm² by a dielectric layer of in the region of 10 μm, having a dielectric constant of in the region of 40. A skilled reader will readily be able to implement the various embodiments based upon the other configurations.

In a similar manner to above, the processor 880 in FIG. 8b is configured to process (if necessary) a data communication signal received from a further interface circuitry 800 by capacitive coupling to remove (if necessary) any processing that has occurred. It will readily be appreciated that in some embodiments the data communication signal may already be in a format for communication via capacitive coupling, or the other apparatus may wish the data communication signal to remain in that particular format. In such arrangements, the processor 880 may not condition the received/provided data communication signal accordingly.

FIG. 8c shows a further embodiment of the interface circuitry 800 in which the processor 880 is in communication with the capacitive coupling elements 840, inductive coupling element 842 and mating coupling elements 845, and is configured to provide for signalling. In this arrangement, the processor 880 is configured to select the particular coupling element based upon the signalling to be provided (e.g. data, power, data speed, data frequency etc.). In the present embodiment, the interface circuitry 800 is configured to communicate data communication signals via any of the coupling elements 840, 842, 845. In this arrangement, frequency communication is communicated via the capacitive coupling elements 840 (e.g. data) and inductive coupling element 842 (e.g. data, power), while dc communication is communicated via the mating coupling elements (e.g. dc data, power).

It will readily be appreciated that in some embodiments the interface circuitry 800 may be provided with no mating coupling elements 845. In such an arrangement, an interface circuitry 800 may be able to communicate (e.g. data, power, etc.) with a further interface circuitry 800 without making touching contact.

It will readily be appreciated that the above embodiment is exemplarily only, and in further embodiments, the interface circuitry 800 may comprise any number of capacitive coupling elements 840 and/or mating coupling elements 845, and/or inductive coupling elements 842. Similarly, processor 880 and/or memory 890 may be provided by another apparatus, in communication with the interface circuitry 800. In such an arrangement the data communication signal may have been conditioned prior to being communicated to the interface circuitry 800 for communication signalling via capacitive coupling/inductive coupling.

In some embodiments the interface circuitry 800/processor 880 is configured to allow for transmission of low frequency signals (e.g. signals towards the DC range, including DC signals) using reactive coupling elements (e.g. capacitive coupling elements 840). In such an arrangement the interface circuitry 800/processor 880 may be provided with DACs/ADCs, modulators/demodulators, amplifiers, etc.

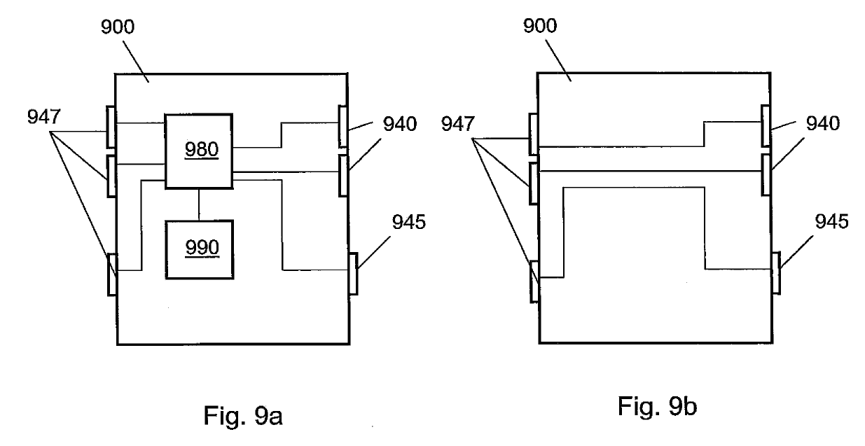

FIG. 9a shows a further embodiment in which an interface circuitry 900 is provided as an adapter, comprising a processor 980 and a memory 990. Here, the processor 980 is in communication with two capacitive coupling elements 940 and a mating coupling element 945, and is in further communication with adapter elements 947. Here, the adapter elements 947 are configured for mating coupling with a further apparatus (e.g. a subscriber identity module, flash memory, etc. having mating coupling elements). Again, any number of elements may be provided.

Each adapter element 947 is configured to correspond to a particular communication coupling element 940, 945. In this arrangement, the processor 980 is configured to provide for signalling by communicating signals between the respective adapter elements 947 and the respective communication elements 940, 945. In some embodiments, the processor 980 is configured to selectively communicate signals to/from the adapter elements 947 to/from particular coupling elements 940, 945 based on characteristics of the signal (e.g. frequency, data rate, etc.). FIG. 9b shows a further embodiment of an interface in which each respective adapter element 947 is in communication with a respective coupling element, without a processor 980/memory 990 arrangement.

It will readily be appreciated that any of the features of any of the above embodiments may be used in conjunction with, or in addition to, or in substitution of any of the other features of any of the other embodiments. For example, while not explicitly recited, it will readily be appreciated to the skilled reader that the embodiment shown in FIG. 8 (for example), may be configured so as to provide for capacitive coupling according to the arrangement of the reactive coupling elements shown in FIG. 6, or the like, or may be provided with inductive coupling elements 842, for example as shown in FIG. 8c. A skilled reader would readily be able to implement such arrangements.

Similarly, while in the above embodiments the concentrator 360, 560, 660, 760, is configured such that it is on a respective reactive coupling element, and extending for over a portion thereof, it will readily be appreciated that in alternative embodiments the concentrator may be provided such that it extends for less/more than the respective coupling element. In some arrangements, the concentrator may form a portion, a side region/surface or all of the case of the interface circuitry/reader/memory. The concentrator, when a dielectric layer, may be provided by any number of materials, such as plastics, ceramics, oxidation layers, etc. The concentrator, when a flux concentrator, may be provided by any number of materials, such as ferrites, nickels, etc.

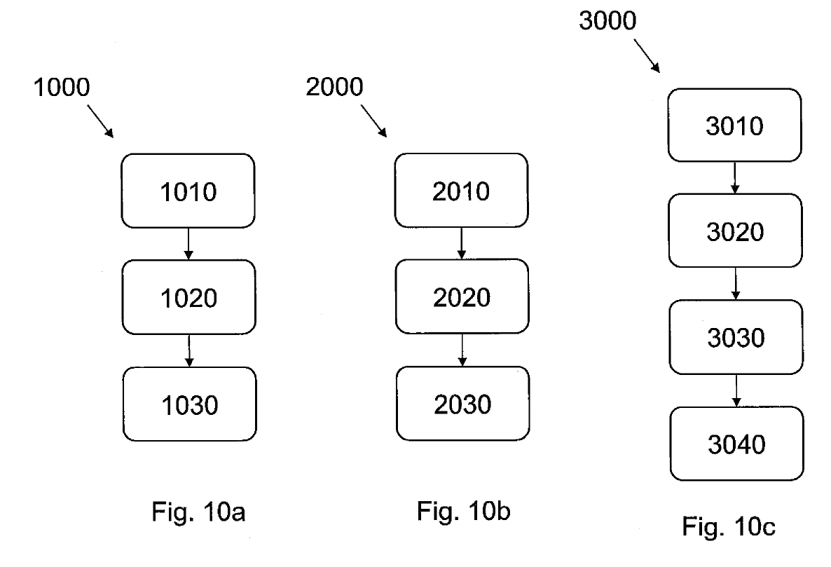

FIG. 10a shows a flow chart 1000 of providing power transmission signalling by using reactive coupling using interface circuitries. This comprises providing 1010 a first interface circuitry and a second interface circuitry, each comprising complementary reactive coupling elements, bringing 1020 the respective interface circuitries into proximity with one another so as to provide for reactive coupling, and providing 1030 power transmission signalling from one interface circuitry to the other interface circuitry using the respective reactive coupling elements.

FIG. 10b shows a flow chart 2000 for providing power transmission and data signalling by using reactive coupling of interface circuitries. This comprising providing 2010 a first interface circuitry and a second interface circuitry, each comprising complementary reactive coupling elements, bringing 2020 the respective interface circuitries into proximity with one another so as to provide for reactive coupling, and communicating 2030 a power and/or data signalling from one interface circuitry to the other interface circuitry using the respective reactive coupling elements.

FIG. 10c shows a flow chart of 3000 for providing powering and data communication signalling by using reactive coupling using interface circuitries. This comprises providing 3010 a first interface circuitry and a second interface circuitry, each comprising complementary reactive coupling elements, bringing 3020 the respective interface circuitries into proximity with one another so as to provide for reactive coupling, and selecting 3030 a particular reactive coupling element (e.g. either a capacitive reactive coupling element, or an inductive reactive coupling element) based on a predetermined criteria of the signalling, and communicating 3040 power and/or data signalling from one interface circuitry to the other interface circuitry using the respective selected reactive coupling elements.

In certain embodiments, the same reactive coupling elements may be used to switch between providing power transmission signalling and data communication signalling. This switching would be done under the control of a processor as mentioned before. In further embodiments, power and data may be simultaneously provided by the same reactive coupling element.

It will be appreciated to the skilled reader that the interface circuitry and/or other features of particular apparatus may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory.

It will be appreciated that the aforementioned circuitry/apparatus/elements may have other functions in addition to the mentioned functions, and that these functions may be performed by the same circuitry/apparatus/element.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those features and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures. The features of the embodiments described herein may be combined in all possible combinations of methods, apparatus, modules, systems, and computer program products.

1. Apparatus for a user removable memory or a device for communication with a user removable memory, the apparatus comprising interface circuitry configured to provide for power transmission signalling between a user removable memory and a device for communication with the user removable memory, the interface circuitry comprising at least one reactive coupling element to provide for the power transmission signalling, via reactive coupling.

2. Apparatus according to claim 1, wherein the interface circuitry is additionally configured to provide for data communication signalling via the at least one reactive coupling element.

3. Apparatus according to claim 1, wherein the interface circuitry is configured to provide for data communication signalling via a capacitive reactive coupling element, and power transmission signalling via an inductive reactive coupling element.

4. Apparatus according to claim 3, wherein the interface circuitry is configured to provide for selective power/data communication signalling based on a predetermined criterion.

5. Apparatus according to claim 4, wherein the predetermined criterion is the frequency of the power/data communication signalling.

6. Apparatus according to claim 1, wherein the interface circuitry further comprises at least one concentrator, associated with the reactive element(s), to provide for reactive coupling.

7. Apparatus according to claim 6 wherein the at least one concentrator is one of: a dielectric and a flux concentrator.

8. Apparatus according to claim 1, wherein the reactive coupling element is located proximal to the exterior of an apparatus comprising the interface circuitry.

9. Apparatus according to claim 1, wherein the interface circuitry is additionally configured for galvanic mating coupling.

10. Apparatus according to claim 9, wherein the apparatus is configured to selectively use galvanic and reactive coupling based on a predetermined criterion.

11. Apparatus according to claim 10, wherein the predetermined criterion is a particular required speed of signalling.

12. Apparatus according to claim 1, further configured to condition a data communication signal to provide for communication via reactive coupling.

13. Apparatus according to claim 12 wherein the apparatus is configured to condition a data communication signal so as to provide for a particular frequency of signal.

14. Apparatus according to claim 1, wherein the apparatus is one of: a user removable memory; a module for a user removable memory; a device for communication with a user removable memory; a module for a device for communication with a user removable memory; an adapter, or module for an adapter, configured for attachment to a user removable memory/device for communication with a user removable memory.

15. Apparatus according to claim 14, wherein the user removable memory, or module for the user removable memory is one of: a subscriber identity module; a smart card; an integrated circuit card; flash memory card, credit card.

16. Apparatus according to claim 14, wherein the adapter comprises mating connection circuitry to provide for mating connection to mating interface circuitry of the user removable memory or device, the adaptor comprising at least one reactive coupling element for signalling with a respective device for signalling with the user removable memory or user removable memory, the adapter configured to adapt the signalling from/to the user removable memory or respective device, via the at least one reactive coupling element.

17. A computer program, storable on a carrier, the computer program comprising computer code to control operation of an apparatus for a user removable memory or a device for communication with a user removable memory, the apparatus comprising interface circuitry configured to provide for power signalling between a user removable memory and an apparatus for communication with the user removable memory, the interface circuitry comprising at least one reactive coupling element to provide for the power transmission signalling, via reactive coupling, the computer code configured to control power transmission signalling via the reactive coupling.

18. A computer program according to claim 17, wherein the interface circuitry is additionally configured to provide for data communication signalling, and the computer code is configured to control power/data signalling using at least one reactive coupling element, according to a predetermined criterion.

19. Means for reading/writing data to a user removable means for memory, the means for reading/writing data comprising means for interfacing configured to provide for power transmission signalling between the user removable means for memory and a means reading/writing data to/from the user removable means for memory, the means for interfacing comprising at least one means for reactive coupling to provide for the power transmission signalling, via reactive coupling.

20. A method of providing power transmission signalling between an apparatus for a user removable memory and a device for communication with the user removable memory, the method comprising providing power transmission signalling via reactive coupling.

21. A method according to claim 19, further comprising providing data communication signalling between an apparatus for a user removable memory and a device for communication with the user removable memory, the method further comprising providing data communication signalling via reactive coupling.
